(19) United States
(12) Patent Application Publication
(10) Pub. No.: US 2021/0016357 A1
(43) Pub. Date: Jan. 21, 2021

(54) DEVICE FOR TWISTING-OFF AND STRIPPING AN ELECTRODE CAP FROM AN ELECTRODE CAP RECEPTACLE AND STRIPPING DEVICE

(71) Applicant: Lutz Precision, k.s., Bratislava (SK)

(72) Inventor: Stefan Fahnenstich, Gols (AT)

(21) Appl. No.: 16/928,984

(22) Filed: Jul. 14, 2020

(30) Foreign Application Priority Data
Jul. 15, 2019 (EP) 19186250.7

(51) Int. Cl. B23B 5/16; B23K 11/30

(52) U.S. Cl. CPC B23B 5/166; B23K 11/3063

(57) ABSTRACT

A device for twisting-off and stripping an electrode cap from an electrode cap receptacle of an end of a welding gun of a welding robot, the device comprising a cap twisting-off unit and further comprising a stripping device. The stripping device is arranged along an insertion path for an electrode cap receptacle with an electrode cap as seen in front of the cap twisting-off unit and along a discharge path for an electrode cap receptacle without or with electrode cap as seen from behind the cap twisting-off unit. The stripping device can be for use in combination with the cap twisting-off unit.

### CROSS-REFERENCE TO RELATED APPLICATION

This application is based on and claims priority under 35 U.S.C. § 119 to European Patent Application No. 19186250.7 filed on Jul. 15, 2019, in the European Patent Office, the disclosure of which is incorporated by reference herein in its entirety.

### TECHNICAL FIELD

This disclosure relates to a device for twisting-off and stripping an electrode cap from an electrode cap receptacle.

### BACKGROUND

Welding robots have a computer-controlled robot arm with a spot welding gun, which has an electrode cap receptacle at each of the opposite gun ends, onto which an electrode cap can be attached. For independent fixing of the electrode caps, the electrode cap receptacles of the welding guns are usually tapered towards their free end (holding cone), so that an attached electrode cap can be fixed on the receptacle under spring action by the pressing force of the welding guns or by means of a predetermined contact pressure.

To change the electrode caps, cap changers are used in robot welding systems, with which the welding caps can be removed from an electrode cap receptacle designed as a holding cone. For this purpose, an electrode cap can be automatically released from the receptacle by a rotary motion. For example, a spur gear can be provided, into whose central opening an electrode cap can be inserted. On a circle around the axis of the spur gear, three clamping jaws can be pivotally mounted on pins projecting on both sides at equal angular distances from each other. Each clamping jaw is loaded with a tension spring in the direction of the electrode cap, so that when the spur gear rotates in one direction, the tension springs pull the clamping jaws against the electrode cap and the electrode cap can be removed from the welding gun. Only when the spur gear is turned in the other direction after the welding guns have been removed from the cap changer is the electrode cap generally released.

Occasionally—at unforeseeable intervals—the problem occurs that after the electrode cap has been twisted off from the welding guns, the electrode cap is not held securely by the clamping jaws, so that the electrode cap is dropped when the welding guns are removed and slides back down onto the welding guns and remains on the welding guns. This generally leads to an emergency stop and a stop of the whole line. The dropped electrode cap must first be removed before the line can start again.

### SUMMARY

The technical problem to be solved is specifying a device for twisting-off and stripping an electrode cap from an electrode cap receptacle and a stripping device for use in combination with a cap twisting-off unit to prevent a twisted off electrode cap from slipping back and remaining on an electrode cap receptacle.

This object is solved by the device according to claim 1 and the stripping device according to claim 9. Further embodiments and further developments are covered by the dependent claims.

The device according to this disclosure for twisting-off and stripping an electrode cap from an electrode cap receptacle of one end of a welding gun of a welding robot comprises a cap twisting-off unit. The device further comprises a stripping device arranged along an insertion path for an electrode cap receptacle with electrode cap upstream of the cap twisting-off unit as viewed from the cap twisting-off unit and along a discharge path for an electrode cap receptacle without or with electrode cap downstream of the cap twisting-off unit as viewed from the cap twisting-off unit.

The stripping device may be provided for stripping from the electrode cap receptacle an electrode cap which has been dropped by the cap twisting-off unit after being twisted off from an electrode cap receptacle and has fallen back onto the electrode cap receptacle, so as to avoid the electrode cap remaining on the electrode cap receptacle when the electrode cap has been dropped by the cap twisting-off unit as the electrode cap receptacle moves along the discharge path.

The cap twisting-off unit can be provided and designed to at least partially engage a peripheral region of an electrode cap which is at least partially inserted into the cap twisting-off unit and, by means of a tensionally force-locking rotation in a first direction of rotation, to engage, hold and twist-off in a tensionally force-locking manner the electrode cap which is at least partially inserted into the cap twisting-off unit. The stripping device may be arranged and designed in such a way that, in the case of an electrode cap at least partially inserted into the cap twisting-off unit for twisting-off the electrode cap, the stripping device surrounds the electrode cap receptacle with at least one obliquely arranged lip at least partially surrounding the electrode cap receptacle, so that it is prevented that while the electrode cap receptacle is moved along the discharge path out of the cap twisting-off unit, a remaining of the electrode cap on the electrode cap receptacle occurs when the electrode cap is dropped by the cap twisting-off unit.

Due to the slope resulting from at least one oblique lip, an electrode cap dropped by the cap twisting-off unit and stripped by the stripping device can be automatically removed by the force of gravity. The direction of gravity may, for example, be in the direction of the discharge path. The slope can be formed with respect to the direction of gravity. A gradient angle of the at least one lip can be determined between an underside of the at least one lip facing away from the cap twisting-off unit and a plane perpendicular to the direction of gravity and/or to the discharge path.

In the device for twisting-off and stripping an electrode cap from an electrode cap receptacle of one end of a welding gun of a welding robot, the stripping device can thus be arranged below, for example vertically below, the cap twisting-off unit.

For example, the central axis of a spur gear of the cap twisting-off unit, into which an electrode cap to be twisted off can be at least partially inserted, and an axis of the stripping device can be aligned such that the direction of the discharge path or the direction of the insertion path run along the central axis of the spur gear.

The stripping device may comprise two lips, which may be equally oblique, the electrode cap receptacle with an electrode cap being movable between the two lips and the electrode cap receptacle being movable out without the electrode cap between the two lips. The provision of two lips allows the stripped electrode cap to be removed in a directional manner.

The stripping device may include an enclosure which may be positioned around the at least one lip in such a way that a discharge path may be formed for the twisted-off and dropped electrode cap. The at least one lip may be located on the enclosure. By means of the enclosure, the stripping device can be arranged on a structure of the device for twisting-off and stripping an electrode cap from an electrode cap receptacle of an end of a welding gun of a welding robot.

The enclosure may comprise two side walls, a crossbar and an end wall. The at least one lip may be placed on the side walls. The crossbar can provide additional stability. The end wall may be provided at the end of the slope so that an electrode cap slipping or rolling down the slope can be stopped or braked by the end wall.

The enclosure may have an opening in a lower part of the at least one lip through which the twisted-off and dropped electrode cap can be removed. The opening may be provided between the end wall and the at least one lip so that a dropped electrode cap can slide or roll down the inclined lip(s) and be stopped or braked by the end wall and enter the opening.

The at least one lip or all lips can be designed as brush or rubber lip. To be able to retain a dropped electrode cap, a certain stiffness of the respective materials is required, but the materials should not damage the surface of the electrode cap receptacle.

A gradient angle of the at least one lip can be in a range of 20° to 50°. The gradient angle may be determined between an underside of the at least one lip facing away from the cap twisting-off unit and a plane perpendicular to the discharge path. The gradient angle of the two lips allows dropped electrode caps to be automatically removed by the force of gravity.

An angle between a surface of at least one lip facing the cap twisting-off unit and the end wall may be in the range of 40° to 70°.

The stripping device of this disclosure for use in combination with a cap twisting-off unit comprises at least one obliquely arranged lip. The stripping device may be the stripping device described above in connection with the device for twisting-off and stripping an electrode cap from an electrode cap receptacle of an end of a welding gun of a welding robot or a stripping device described below.

The stripping device may comprise two lips, which may be arranged equally oblique.

The striping device may further include an enclosure which may be positioned around the at least one lip in such a way that a discharge path may be formed for a twisted-off and dropped electrode cap.

The enclosure may comprise two side walls, a crossbar and an end wall.

The enclosure may have an opening in a lower part of at least one lip through which a twisted-off and dropped electrode cap can be removed.

The at least one lip or all lips can be designed as brush or rubber lip.

A gradient angle of at least one lip can be in a range of 20° to 50°.

An angle between a surface of at least one lip facing a cap twisting-off unit and the end wall may be in the range of 40° to 70°.

### BRIEF DESCRIPTION OF THE DRAWINGS

For a more complete understanding of this disclosure, reference is now made to the following description, taken in conjunction with the accompanying drawings, in which:

FIG. 1 illustrates a schematic oblique view from above of a device for twisting-off and stripping an electrode cap from an electrode cap receptacle of one end of a welding gun of a welding robot;

FIG. 2 illustrates a front view of a stripping device on the end wall;

FIG. 3 illustrates a schematic side sectional view of the stripping device of FIG. 2;

FIG. 4 illustrates a top view of the stripping device; and

FIGS. 5A-5E illustrate schematic diagrams of an electrode cap removal process from the electrode cap receptacle by means of the stripping device.

### DETAILED DESCRIPTION

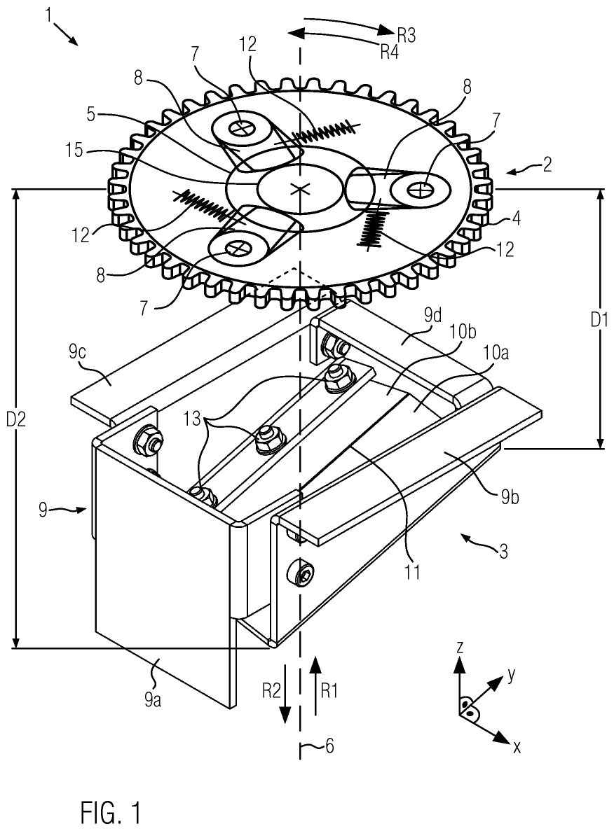

FIG. 1 illustrates a schematic oblique view from above of a device 1 for twisting-off and stripping an electrode cap 15 from an electrode cap receptacle of one end of a welding gun of a welding robot. It shows a part of a cap twisting-off unit 2 and a stripping device 3 located below it. The cap twisting-off unit 2 and the stripping device 3 are located at holding structures (not shown) of the device 1.

The cap twisting-off unit 2 comprises in a spur gear 4 a central opening 5, into which an electrode cap receptacle with an electrode cap 15 can be inserted from below, in a first direction R1 along an insertion path, and the electrode cap receptacle can be removed without the electrode cap downwards, in a second direction R2 along a discharge path. For example, the direction of gravity may also be in the second direction R2.

On a circle around a central axis 6 of the spur gear 4, three clamping jaws 8 are pivotally mounted on each of the two projecting pins 7 at equal angular distances from each other, whereby the upper three clamping jaws 8 are shown in FIG. 1. The insertion path and the discharge path can run along the axis 6.

Each clamping jaw 8 is loaded with a tension spring 12 in the direction of an inserted electrode cap. If the spur gear 4 swivels clockwise (arrow R3), the tension springs 12 pull the clamping jaws 8 against an inserted electrode cap 15, which can thus be grasped and held increasingly tighter and then twisted off from the electrode cap receptacle. If the electrode cap receptacle is then moved downwards in the second direction R2 along the discharge path out of the cap twisting-off unit 2, the twisted off electrode cap 15 generally remains in the cap twisting-off unit 2 for the time being, since it is held there.

After moving the electrode cap receptacle out, the spur gear 4 rotates counterclockwise (arrow R4), when switching over a motor not shown, so that the clamping jaws 8 open and the twisted-off electrode cap 15 can fall out and reach a discharge device. Subsequently, another electrode cap receptacle with an electrode cap 15 can be inserted into the opening 5 of the spur gear 4.

Since it can happen from time to time that an electrode cap 15 is not held by the cap twisting-off unit 2 after being twisted off and slips back onto the electrode cap receptacle, the stripping device 3 is located below the cap twisting-off unit 2. In the illustration, the stripping device 3 comprises a housing 9 with two side walls 9b, 9c, a crossbar 9d and an end wall 9a. Two lips 10a, 10b are arranged on the side walls 9b, 9c, which lie against each other in an edge area 11.

The two lips 10a, 10b are each connected to the side walls 9b, 9c, here by screws 13, in a side area opposite the edge area 11.

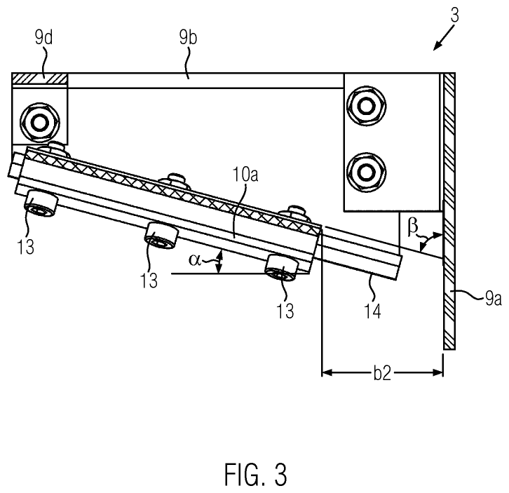

The gradient angle (see also FIG. 3) of the two lips 10a, 10b lies in a range of 20° to 50°. This gradient angle is determined by the design of the side walls 9b, 9c. Due to the gradient angle, an electrode cap on the surface of the two lips 10a, 10b facing the cap twisting-off unit 2 can slip towards the end wall 9a due to the action of gravity. The direction of gravity can be in the second direction R2, for example.

If a Cartesian coordinate system is used as a basis, the first direction R1 can run in a positive z direction and the second direction R2 in a negative z direction. The y-axis can be perpendicular to the end wall 9a and the x-axis parallel to the end wall 9a.

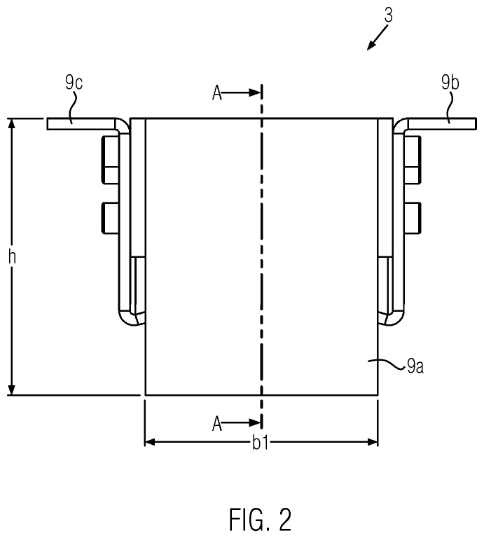

FIG. 2 illustrates a front view of the stripping device 3 on the end wall 9a. The end wall may have a width b1 in a range from 45 mm to 50 mm and a height h in a range from 42 mm to 46 mm.

FIG. 3 illustrates a schematic lateral sectional view along A-A from FIG. 2. Assuming that the end wall 9a is parallel to the longitudinal axis 6 of the spur gear 4, the gradient angle α and the angle β between a surface of the two lips 10a, 10b facing the cap twisting-off unit 2 and the end wall 9a can be given as shown. An opening 14 is provided between the two lips 10a, 10b and the end wall 9a through which the dropped and stripped electrode caps can be discharged. Due to the gradient angle a of the two lips 10a, 10b, the dropped and stripped electrode caps are automatically discharged by the force of gravity.

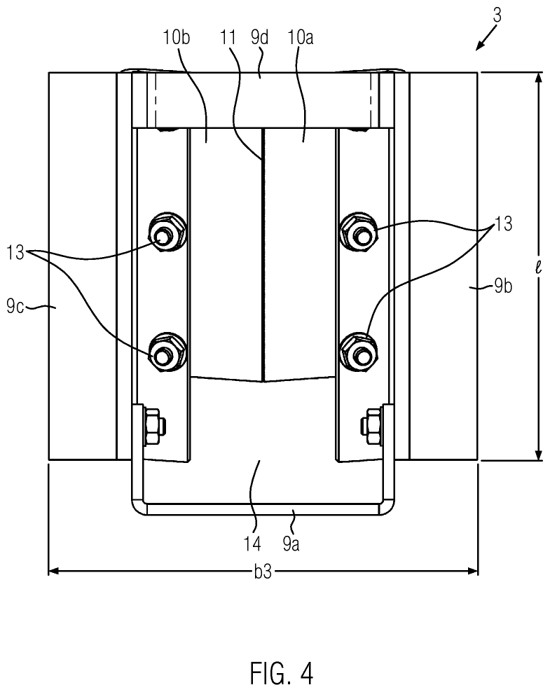

FIG. 4 illustrates a top view of the stripping device 3. A length 1 can be in a range of 65 mm to 75 mm and a width b2 in a range of 70 mm to 80 mm.

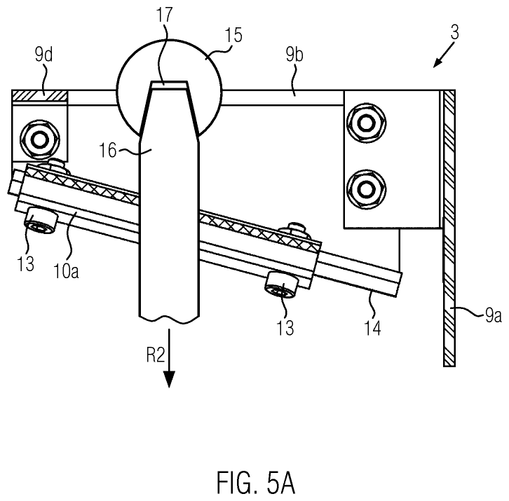

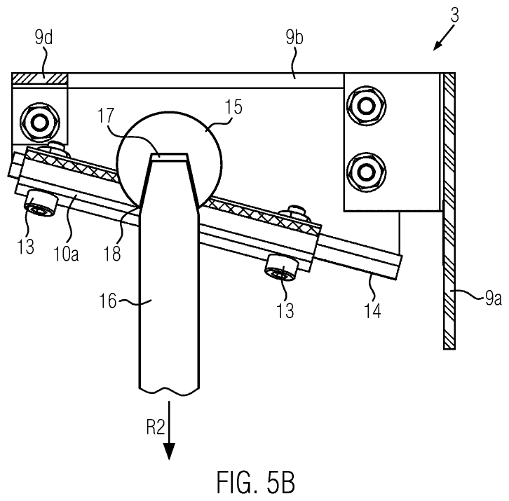

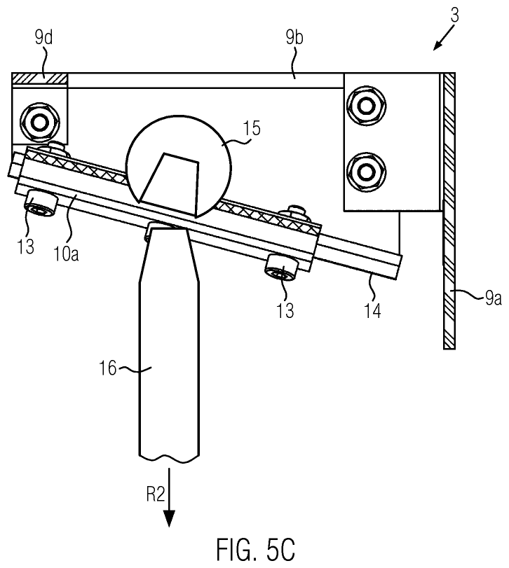

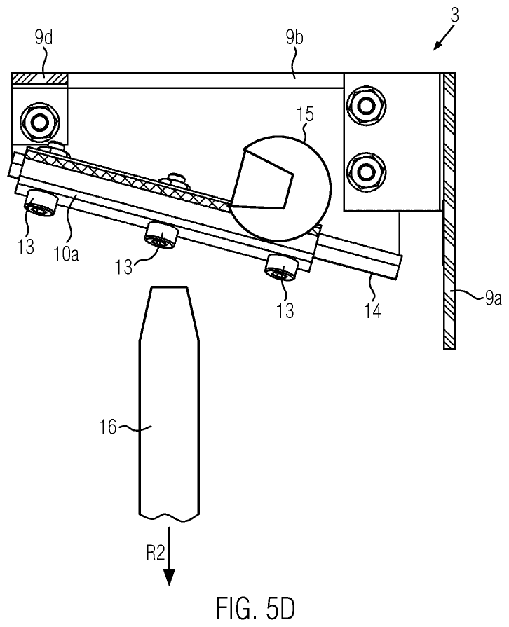

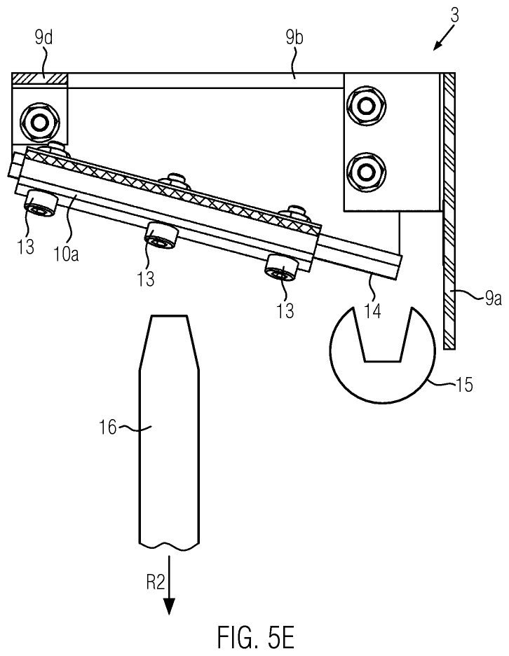

FIGS. 5A-5E illustrate schematic representations of a stripping process of an electrode cap 15 from the electrode cap receptacle 16 by means of the stripping device 3. The stripping device 3 is shown in the lateral sectional view from FIG. 3.

In FIG. 5A, an electrode cap receptacle 16 with an electrode cap 15, which was dropped from the electrode cap receptacle 16 by a cap twisting-off unit (not shown) after being twisted off from the electrode cap receptacle 16 and remained on the electrode cap receptacle 16, is moved downwards in the second direction R2 along the discharge path by the stripping device 3. That the electrode cap 15 is no longer fixed on the electrode cap receptacle 16 is indicated by the free area 17 between the electrode cap receptacle 16 and the electrode cap 15.

In FIG. 5B, the electrode cap receptacle 16 with the electrode cap 15 has been moved in the second direction R2 to such an extent that the electrode cap 15 at least partially comes into contact with the two lips 10a (10b not shown) in a area 18 and thereby the stripping of the electrode cap 15 from the electrode cap receptacle 16 begins.

In FIG. 5C, the electrode cap receptacle 16 has now been moved even further in the second direction R2, so that the electrode cap 15 has now been completely stripped off the electrode cap receptacle 16 by the two lips 10a (10b not shown). The stripping is finished, and the stripped electrode cap 15 can roll down the slope of the two lips 10a (10b not shown) under the effect of gravity in the direction of the opening 14 provided between the two lips 10a (10b not shown) and the end wall 9a.

FIG. 5D shows how the stripped cap 15 approaches the opening 14 by rolling down the slope.

FIG. 5E shows how the stripped cap 15 falls down through the opening 14. The electrode cap 15 can be fed to a waste container, for example.

What is claimed is:

1. A device for twisting-off and stripping an electrode cap from an electrode cap receptacle of an end of a welding gun of a welding robot, the device comprising:
a cap twisting-off unit; and
a stripping device arranged along an insertion path for the electrode cap receptacle with the electrode cap as seen from the cap twisting-off unit and along a discharge path for the electrode cap receptacle without or with the electrode cap as seen behind the cap twisting-off unit.

2. The device of claim 1, wherein the cap twisting-off unit is operable to at least partially engage a peripheral region of the electrode cap at least partially inserted into the cap twisting-off unit and, by means of a tensionally force-locking rotation in a first direction of rotation to grip, hold and twist-off in a tensionally force-locking manner the electrode cap at least partially inserted into the cap twisting-off unit, and
wherein the stripping device is operable to, when the electrode cap is at least partially inserted into the cap twisting-off unit in order to twist-off the electrode cap, at least partially surround the electrode cap receptacle with at least one obliquely arranged lip, to prevent, while the electrode cap receptacle is moved along the discharge path out of the cap twisting-off unit, the electrode cap from falling back and remaining on the electrode cap receptacle when the electrode cap is dropped by the cap twisting-off unit.

3. The device of claim 2, wherein the stripping device comprises two lips which are equally obliquely arranged, the electrode cap receptacle being movable with the electrode cap along the insertion path between the two lips, and the electrode cap receptacle being movable out without the electrode cap along the discharge path between the two lips.

4. The device of claim 2, wherein the stripping device comprises an enclosure which is arranged around the at least one lip in such a way that the discharge path is formed for the twisted-off and dropped electrode cap.

5. The device of claim 4, wherein the enclosure comprises two side walls, a crossbar, and an end wall.

6. The device of claim 4, wherein the enclosure is in a lower region of the at least one lip and has an opening through which the twisted-off and dropped electrode cap can be removed.

7. The device of claim 2, wherein the at least one lip is a brush or a rubber lip.

8. The device of claim 2, wherein a gradient angle (α) of the at least one lip is in a range of 20° to 50°.

9. A stripping device for use in combination with a cap twisting-off unit, the stripping device comprising:
at least one obliquely arranged lip.

10. The stripping device of claim 9, further comprising two lips which are equally obliquely arranged.

11. The stripping device of claim 9, further comprising an enclosure arranged around the at least one lip in such a way that a discharge path is formed for a twisted-off and dropped electrode cap.

12. The stripping device of claim 11, wherein the enclosure comprises two side walls, a crossbar, and an end wall.

13. The stripping device of claim 11, wherein the enclosure has an opening in a lower region of the at least one lip through which the twisted-off and dropped electrode cap can be removed.

14. The stripping device of claim 9, wherein the at least one lip is a brush or a rubber lip.

15. The stripping device of claim 9, wherein a gradient angle (α) of the at least one lip is in a range of 20° to 50°.
